(19) United States
(12) Patent Application Publication
(10) Pub. No.: US 2013/0038289 A1
(43) Pub. Date: Feb. 14, 2013

(54) BATTERY-CELL CONVERTER SYSTEMS

(71) Applicant: Lawrence Tze-Leung Tse, Fremont, CA (US)

(72) Inventor: Lawrence Tze-Leung Tse, Fremont, CA (US)

(73) Assignee: Lawrence Tze-Leung Tse, Fremont, CA (US)

(21) Appl. No.: 13/651,386

(22) Filed: Oct. 13, 2012

Related U.S. Application Data
(63) Continuation-in-part of application No. 12/709,459, filed on Feb. 20, 2010.

(51) Int. Cl. H02J 7/00

(52) U.S. Cl. 320/118; 320/126

(57) ABSTRACT

A battery-cell converter (BCC) management system is disclosed. The BCC system comprises one or more battery-cell converter units that are configured to provide regulated main power output from the outputs of DC/DC converters inside the battery-cell converter units. Each battery-cell converter unit comprises an electrical energy storage cell bank, one or more DC/DC converters, one or more electrical connection devices and a monitor and control module coupled to other components of the battery-cell converter unit. Multiple battery-cell converter units can be stacked in series to increase output voltage. In another embodiment, multiple battery-cell converter units can be connected in parallel to increase output current. Accordingly, the BCC management system disclosed improves battery pack usage efficiencies, increase battery pack useable time per charge, extend battery pack life-time as well as lower battery pack manufacturing cost.

### CROSS REFERENCE TO RELATED APPLICATIONS

The present invention is continuation-in-part of and claims priority to U.S. Non-Provisional patent application, Ser. No. 12/709,459 filed on Feb. 2, 2010, entitled “Battery-Cell Converter Management Systems”, which claims priority to U.S. Provisional Patent Application, Ser. No. 61/208,304, filed on Feb. 23, 2009, entitled “Multi-cell battery management systems”. The U.S. Non-Provisional Patent Application and U.S. Provisional Patent Application are hereby incorporated by reference in their entireties.

### FIELD OF THE INVENTION

The present invention generally relates to systems and methods of constructing a battery unit out of a plurality of battery cells coupled to or integrated with a plurality of voltage/current converter units for wear-leveling (equalizing ageing) of rechargeable batteries in a multi-cell battery system.

### DESCRIPTION OF RELATED ART

With the growing requirements of high-energy battery-operated applications, the demand for multi-cell battery packs has been increasing drastically. Multi-cell is needed to serve the high capacity/energy requirements of certain battery applications. The conventional configuration of a multi-cell battery pack consists of string(s) of series-connected or series-stacked cells. For example, FIG. 1 illustrates a battery pack 100 with four 1.2-volt cells connected in series and the battery pack provides a nominal voltage of 4.8V. Each cell 110 consists of a positive terminal 120 and a negative terminal 130. Other applications such as battery packs 200 for laptop computers may have four 3.6-volt cells 220 connected in series to provide a nominal battery pack output voltage of 14.4V as shown in FIG. 2. In addition, two of such 4-cell strings 210 may be connected in parallel to increase the capacity from 2000 milli-Amp-hours (mAh) to 4000 mAh. This configuration is generally known in the industry as 4S2P, or 4-cell series 2-in-parallel. At this moment, high-capacity multi-cell rechargeable battery packs used in handheld appliances, computers, power tools, etc., are rather expensive.

A battery cell can be damaged by being excessively charged to a high voltage or excessively discharged to a low voltage. This is particularly true for Lithium-ion and Lithium polymer-based batteries. The high- and low-voltage cutoffs are typically around 4.2V and 2.7V respectively. The discharge rate characteristics of a typical Li-ion battery are shown in FIG. 3. After the battery discharges to about 2.7-3.0V, the battery quickly dies out and may be damaged.

Therefore, it is critical to provide a rechargeable battery pack with a battery management system facilitating over-charge, over-discharge, and over-temperature protections. Also it is desirable to provide SOC (State-Of-Charge) and SOH (State of Health) monitoring for the battery cells in a pack since SOC and SOH can provide critical info relating to the remaining charge or life of the battery cells. Such battery management system may prevent over-charge and over-discharge of battery cells. Battery over-charge and over-discharge may reduce battery capacity and battery lifetime, and may even cause hazardous conditions such as fires and explosions.

One of the key challenges in charging/discharging a string of series-stacked multi-cell battery units is related to the non-uniformity of battery cells within the pack due to manufacturing tolerances. There are several types of battery cell mismatch. FIG. 4A illustrates a scenario of C/E (capacity/energy) mismatch, where a battery cell pack 400 includes cells 410a, 410b and 410b. Cell 410b has smaller capacity/energy than cells 410a and 410c, where smaller capacity/energy is symbolically shown by a smaller “bucket size”. When cell 410b is fully charged, it will provide less charge during operation than cells 410a and 410c. FIG. 4B illustrates a scenario of SOC (State-Of-Charge) mismatch, where a battery cell pack 420 including cells 430a, 430b, and 430c. State-of-charge mismatch is a more common issue in rechargeable batteries and the problem occurs when initially equal-capacity cells gradually diverge to contain different amounts of charges. In the example shown in FIG. 4B, cells 430a and 430c are fully charged, while cell 430b is not fully charged. There are various reasons why a series-stacked string of cells incur noticeably different SOC. The SOC differences may be caused by both intrinsic and extrinsic factors. For example, temperature difference between two cells may be caused by an extrinsic factor, such as where one cell is physically closer to the CPU (a major heat source) inside a laptop computer than another cell. Inherent non-uniformity of materials or physical dimensions of cells are examples of intrinsic factors. These intrinsic and extrinsic factors cause differences in the state of health (SOH) of the cells, and hence create different aging rates among cells. These factors ultimately contribute to different SOC as the series-stacked cells are discharged with same current load.

A weakest battery cell tends to limit the overall capacity of the entire battery pack unit. Therefore, special manufacturing processes are needed to ensure tighter tolerance. One example of such special manufacturing process involves binning and grouping cells based on their capacity properties. Accordingly, a pack will use cells from the same bin. Factories that do not adopt the binning process may result in low battery yield on their battery cells. Besides, the out-of-spec cells will be rejected and disposal of the out-of-spec cells will increase environment pollution. However, such process increases manufacturing cost.

It is apparent that this binning step is a brute-force approach and can only partially mitigate the cell mismatch issue since cell mismatches tend to get worse after multiple charge/discharge cycles. Also, mismatches may result from different cell temperatures in the operating environment. As a result, mismatch degradations occur more often after battery cells are manufactured and therefore cannot be easily addressed during battery cell manufacturing and quality control.

In addition, a battery pack that includes a series of stacked battery cells will no longer be functional if any given cell in the stack is severely degraded. FIG. 4C illustrates an example such as the case, where battery cell pack 440 includes series-stacked cells 450a, 450b and 450c. When cell 450b is severely degraded, it causes the whole battery cell pack 440 to fail. In other words, the life time of a battery pack is dominated by the weakest cell. Therefore, it is essential to have a smart battery management system that can ensure safety, extend battery life and reduce battery manufacturing cost.

The Li-ion battery charging process typically uses a two-phase charging process, where medium accuracy constant-current (CC) charging is used in the first phase and high-accuracy constant-voltage (CV) charging is used in the second phase. This is to allow the cell to be fully charged to the desired voltage while preventing the cell from being overcharged. Such charging control is more straightforward for a single battery cell. However, it becomes a complex task for a series string of battery cells when the cells are not well-matched. Hence, cell balancing during charging is used to ensure each of the cells will not be overcharged while allowing each cell to be charged to near its respective capacity. The concept of cell “balancing” refers to the process of monitoring and adjusting the charges stored in each of the cells in the battery pack. Consequently, the process can balance the terminal voltage and/or the amount of stored charge of each of the cells within the voltage limits and manage the SOC of the cells via fuel gauging. Since the cells often are not identical, mismatches among cells exist. The process of balancing may involve purposely dissipating energy stored in the cells that have higher terminal voltages or SOC in order to avoid cell overcharging and to equalize the SOC among all cells in a given charging instance. Alternatively, charge can be moved from more charged cells to less charged cells to equalize the SOC among cells.

In conventional approaches, battery charging management mostly focuses on uniform charging to ensure that each of the cells is charged to its respective capacity. While the conventional approaches ensure each cell reaches the charging terminal voltage limits through the balancing act in a multi-cell battery pack, they ignore mismatches among cells during discharge cycles. In order to mitigate the operational limitation due to weak cell, some conventional approaches explore methods of transferring charge from stronger cells to weaker cells in a multi-cell battery pack using charge sharing methods via switched capacitors or using DC/DC to transfer charges from a stronger cell to a weaker cell. In practice, battery cell balancing via charge transfer is typically limited to charge transfer to a neighboring cell. It is impractical to implement a matrix of charge transfer circuits that would provide a charge transfer path to any two cells. In addition, there are losses associated with charge balancing or charge transferring between cells.

Many multi-cell battery packs are configured in series-parallel fashion as shown in FIG. 2. As an individual cell becomes defective such as open circuited, the whole chain of series-stacked cells cannot be used and the multi-cell battery unit capacity is immediately halved. Similar to any conventional battery packs, the battery system topology as shown in FIG. 2 has the electrical load connected directly to the string of series-stacked battery cells (typically to the top and the bottom of the string). As each of the cells or storage elements discharges, the terminal voltage across each of the cells as well as the string of series-stacked cells decreases. Therefore, the electrical load that directly connects to the string of series-stacked cells (the output of the pack), sees a large variation in pack output voltage as cells are discharged. Consequently, the conventional way of load connection to the battery pack imposes a harsh requirement for the load to withstand a large operating voltage range. The load corresponds to the electronic circuits deriving power from the battery pack. Therefore, the direct connection to the string of series-stacked cells not only makes the design of the associated electronic circuits very challenging, but also requires those circuits to be over designed to accommodate the large variations in the input voltage. The need to operate under a large voltage range also creates system inefficiencies, waste energy and increase system cost.

In other applications with large arrays of cells such as electrical vehicles (EVs), the series-stacked topology creates even more undesirable characteristics. In EV applications, topology of series-stacked cells is used, where one hundred or more Li-ion cells may be involved. If one of the cells in the series of cells ages faster than others or prematurely dies, the entire series-stacked string's capacity will be limited by the weakest cell or the entire string may become malfunction. Therefore, many redundant strings of series-stacked cells need to be incorporated in parallel to improve pack system reliability. The overly designed redundancy adds more cost, space, and weight, etc.

To mitigate/minimize impact of the weakest cell or most mismatched (with lowest capacity) cell on pack capacity/life in the conventional battery pack based on the topology of series-stacked cells, it is ultimately important not to mix and match cells with different size/capacity, different chemistries, or different manufacturers. Even for the same manufacturer, it is advisable not to mix and match cells from different lots. Since managing cell matching is such a critical practice for maximizing pack capacity and pack life, sophisticated and expensive cooling system is often used in EV battery system to ensure cell temperatures are within 1 to 2 degree Celsius so that the cells can have as similar aging rates as possible (cell aging rate is a function of temperature).

For the reasons stated above, battery cells manufacturing, battery system cost and system development efforts can be drastically relieved if one has no concern of cell mismatches. Therefore, it is desirable to develop a technical solution that can relieve the constraints of highly matched cells.

Another key disadvantage of conventional battery system is that the output voltage drops as cells are discharged as mentioned earlier. In the case of EV applications, the motor is powered by the EV battery pack, the motor needs to be over-designed in order to accommodate the large variation of input system voltage from the battery pack. Again, such requirement adds additional cost, space and weight, etc. In addition, as cells age, the internal resistance of the cells increases. During acceleration of an EV, large amount of power or current is drawn from the battery. This causes the output voltage of the pack to drop. This characteristic imposes additional system design challenges on the electrical motor system, which again translates into higher system cost in order to circumvent this voltage drop issue during EV acceleration. Based on the discussions above, it is highly desirable to have a battery system that provides a regulated, managed output.

### BRIEF SUMMARY OF THE INVENTION

A Battery-Cell Converter (BCC) system using multiple battery cells is disclosed. A BCC system incorporating embodiments of the present invention comprises one or more battery-cell converter units, where each battery-cell converter unit comprises an electrical energy storage cell bank, one or more DC/DC converters, one or more electrical connection devices and a monitor and control module. The battery-cell converter units are configured to provide one or more regulated main power outputs from outputs of the DC/DC converters of the battery-cell converter units. The electrical energy storage cell bank comprises multiple energy storage devices and each energy storage device has a first terminal corresponding to positive or negative terminal and a second terminal corresponding to the opposite polarity from the first terminal. The electrical connection devices are coupled to the energy storage devices and the DC/DC converters. The monitor and control module can configure the electrical connection devices and the DC/DC converters according to state of charge, state of health, or system characteristics.

The BCC system can be configured by the monitor and control modules or a main control unit to manage the mismatch among the energy storage devices. For example, the BCC system can be configured to draw less charge from a weaker energy storage device than a stronger energy storage device. Consequently, the BCC system can manage and equate the ageing of the energy storage devices. The BCC system can be configured to disconnect a defective energy storage device from the BCC system so that the rest of the energy storage devices can continue to operate. In another embodiment, the BCC system can be configured to cause a weaker energy storage device connected to said one or more inputs of said one or more DC/DC converters for a shorter period than a stronger energy storage device. The battery-cell converter units can be stacked in series to provide a higher voltage output. The battery-cell converter units can be connected in parallel to provide a higher current output. Furthermore, the series-stacked battery-cell converter units can be connected in parallel to provide higher voltage and current output.

### BRIEF DESCRIPTION OF THE DRAWINGS

FIG. 1 illustrates a conventional multi-cell battery arrangement, where multiple calls are stacked in series.

FIG. 2 illustrates a conventional multi-cell battery with series-parallel arrangement, where two stacked- cells in series are connected in parallel.

FIG. 3 illustrates charging properties for a typical Lithium Ion battery cell.

FIG. 4A illustrates an example of degraded battery pack associated with battery cell capacity/energy mismatch.

FIG. 4B illustrates an example of degraded battery pack associated with battery cell state of charge mismatch.

FIG. 4C illustrates an example of degraded battery pack with a defective battery cell.

FIG. 5A illustrates a block diagram of an exemplary Battery Cell Converter unit incorporating an embodiment of the present invention.

FIG. 5B illustrates a block diagram of an exemplary multi-cell Battery Cell Converter unit incorporating an embodiment of the present invention.

FIGS. 6A-6C illustrate exemplary circuits corresponding to buck/boost, buck, and boost DC/DC converters respectively, where the DC/DC converters can be used in the Battery Cell Converter.

FIG. 7 illustrates the circuit schematic and clock waveforms for an exemplary BCC system using two cells and a DC/DC converter with shared components.

FIG. 8 illustrates a simplified circuit schematic of a BCC system with two parallel battery cells.

FIG. 9A illustrates the circuit schematic and clock waveforms for an exemplary two-phase BCC system with multiple parallel-connected cells, with local cell redundancy and with global cell redundancy.

FIG. 9B illustrates the circuit schematic and clock waveforms for an exemplary two-phase BCC system, where a single cell is coupled to two DC/DC converters or a two-phase DC/DC converter.

FIG. 9C illustrates the circuit schematic and clock waveforms for an exemplary two-phase BCC system with a set of coupled inductors, each coupled to a dedicated phase of a two-phase DC/DC converter.

FIG. 10 illustrates the circuit schematic for an exemplary two-phase BCC system with local cell redundancy and global cell redundancy.

FIG. 11 illustrates the circuit schematic for an exemplary BCC system with stacked Battery Cell Converters.

FIG. 12A illustrates the circuit schematic for an exemplary BCC system with stacked Battery Cell Converters, where the system includes a central monitor control unit.

FIG. 12B illustrates the circuit schematic for an exemplary BCC system with stacked Battery Cell Converters, where the system includes local and central monitor control units.

FIG. 12C illustrates the circuit schematic for another exemplary BCC system with stacked Battery Cell Converters, where the system includes local and central monitor control units and these control units are connected in a daisy chain.

FIG. 13 illustrates the circuit schematic for an exemplary BCC system with two stacked Battery Cell Converters, where the system includes local redundancy.

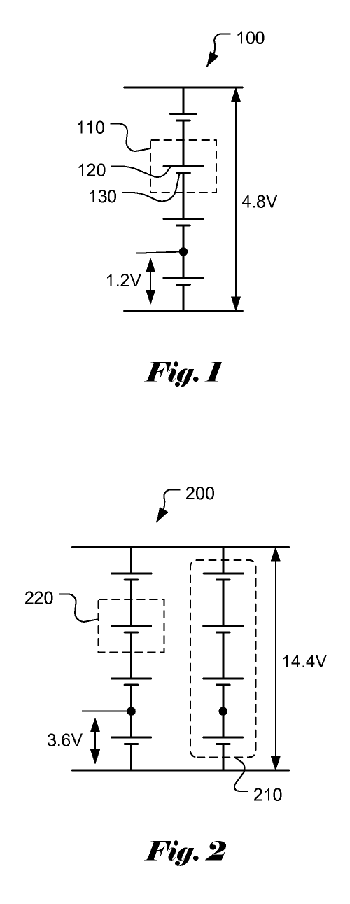

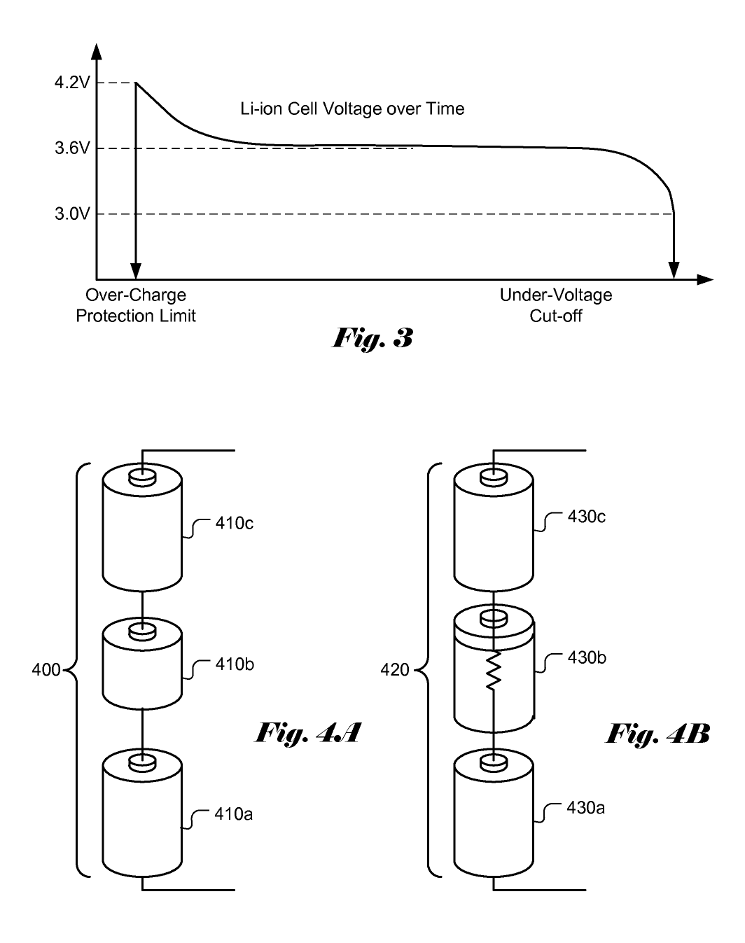

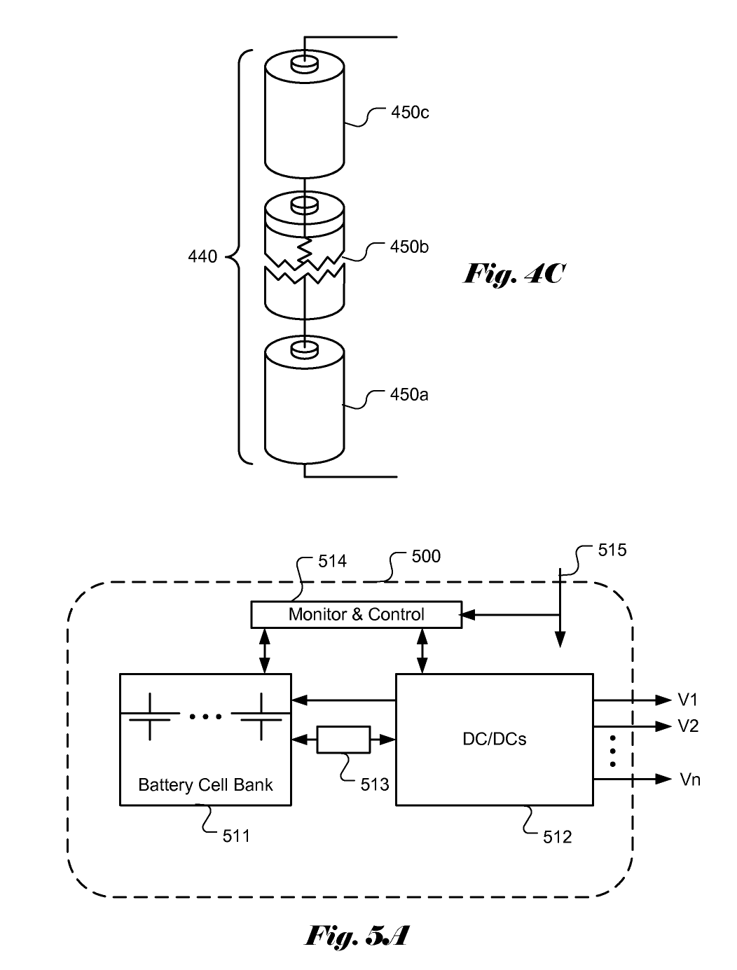

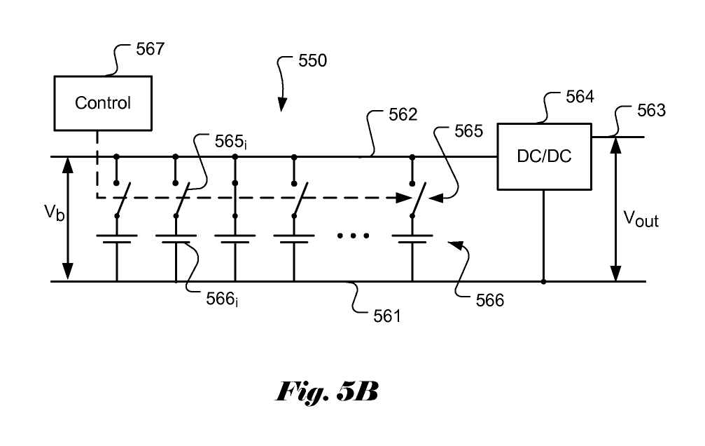

### DETAILED DESCRIPTION OF THE INVENTION

As mentioned earlier, various types of cell mismatches exist among battery cells. When multiple battery cells with mismatches are used to create a battery pack, the weakest battery cell often determines the usability and life time of the battery pack. Therefore, the present invention eliminates the requirement of tightly matched cells within the battery pack while providing a regulated, managed output to the subsequent electrical loads. There are several main differences between a system incorporating an embodiment of the present invention and a convention system. One main difference is that there is no need to transfer charges from one battery cell to another in the system incorporating an embodiment of the present invention. While convention system stacks up battery cells to achieve a higher voltage output, a system incorporating an embodiment of the present invention achieve a higher voltage output by either using a DC/DC boost converter to boost the voltage of the energy storage devices (cells) through connecting device in series, parallel, or a combination thereof or by stacking up the output of the DC/DC converter of each of the series-stacked basic BCC unit to achieve much higher output voltage. In a system incorporating an embodiment of the present invention, energy storage devices (cells) are isolated from the external electrical load by DC/DC converters and electrical power or energy is delivered to the external load through DC/DC converter(s). Furthermore, in the system incorporating an embodiment of the present invention, the battery pack output voltage is a regulated, managed electrical output through the DC/DC converter.

Disclosed herein in exemplary embodiments are a series of new system configurations and new methodologies which include the coupling of one or more DC/DC converters to one or more battery cells. These system configurations, herein referred to as Battery Cell Converters (BCC), provide a near constant voltage output or near constant multiple voltage outputs or output voltages at programmable fixed or time varying levels; the system topologies and algorithms also optimize the usage and reliability of individual battery cell as well as the battery pack system as a whole.

A block diagram of a multi-cell BCC system incorporating an embodiment of the present invention is shown in FIG. 5A. BCC unit 500 comprises one or more energy-storing battery cells 511 and one or more DC/DC converters 512 each having input and output terminals. The terminals of the energy-storing battery cells are coupled to or integrate with input terminals of one or more of said DC/DC converters via one or more electrical connecting devices 513 as shown in FIG. 5A.

The BCC system may have multiple voltage outputs (V1, V2, . . . , and Vn). These voltage outputs are also outputs of DC/DC converters, which can be monitored and controlled by a monitoring and control unit 514. An external charging source 515 is used to charge BCC unit 500, where the configuration is known in the art and the detail is not shown. There are various ways to charge the BCC system unit. For example, upon detecting the presence of active external charging source by the monitor and control unit 514, the DC/DC converter inputs will then be switched over to the incoming external charging source. So the DC/DC converter (or the BCC) outputs continue to be available. In the mean time, part of the incoming energy from the external source will be diverted to charge the battery cells by the monitor and control unit. Alternatively, the external power source can be applied to one or more outputs of one or more of the DC/DC converters 512. Those DC/DC converters can then operate at negative forward power to charge to one or more battery cells in 511.

FIG. 5B shows an exemplary system configuration of multi-cell BCC unit 550 incorporating an embodiment of the present invention. The energy-storing devices referred in this disclosure refer to any suitable devices that can store energy to power electric or electronic devices. Accordingly, an energy-storing device includes battery cells as well as capacitors, such as super capacitors or ultra capacitors. The capacitor-based energy-storing devices suffer from similar constraints/limitations as battery cells due to the limit of maximum charged voltage and mismatches between units. Battery cells 566 are connected to rails 561 and 562 through switches 565. In FIG. 5B, battery cell 566ᵢ represents one of the battery cells 566 and switch 565ᵢ represents one of the switches 565, where i=1, 2, . . . , n and n is an integer. A “cell”, also referred to as an “energy storage device” in this disclosure, is considered a single cell as a group of battery cells directly connected in parallel and/or in series. While switches 565 are connected in series between the high-voltage rail 562 and respective positive terminals of battery cells as shown in FIG. 5B, switches 565 may also be connected in series between the low-voltage rail 561 and respective negative terminals of battery cells 566. The switches are controlled by a control unit 567, where the control signal for the switches 565 is shown as a dashed arrow in FIG. 5B. As shown in FIG. 5B, the negative terminals of battery cells 566 are connected to a common node 561. The other terminal of each battery cell is connected to a switch. By configuring the switches 565, individual battery cell can be selectively connected to or disconnected from the input of the DC/DC converter. Each battery cell is connected to at least one input of the DC/DC converter through a switch.

In FIG. 5B, only one switch is closed while other switches are opened. The switches can be individually controlled by control unit 567. While only one switch is closed in the example of FIG. 5B, more than one switch can be closed at the same time. The on/off switching mechanisms are controlled by the BCC control algorithm applicable to specific applications or by a load-dependent adaptive algorithm. The voltage Vb across one or more battery cells may vary from cell to cell, and may also vary according to the state of discharge of individual battery cells. The DC/DC converter 564 converts voltage Vb to a programmable, pre-determined or time varying voltage Vout. Therefore, the BCC system 550 incorporating an embodiment of the present invention provides a near constant output voltage or a well regulated, programmable time varying output voltage. Vout can be larger or smaller than Vb.

For the Battery Cell Converter configuration as shown in FIG. 5B, there are numerous possible operating modes as determined by the switching sequencing control algorithm for switches 565. The switching sequencing control algorithm can be performed by the control unit 567. The following examples are described to illustrate various control algorithms incorporating embodiments of the present invention.

Sample control 1. The control algorithm selects one of the battery cells 566 to connect to the DC/DC converter 564 at a time. The voltage Vb of the connected cell is monitored by control unit 576. When the voltage Vb drops below a pre-determined threshold, the connected cell will then be considered as “discharged” by control unit 567. The control unit then selects a non-discharged” cell by opening the switch associated with the “discharged” cell and closing the switch associated with the “non-discharged” cell selected.

Sample control 2. The control algorithm selects each battery cell 566ᵢ one at a time in a sequential round-robin fashion by configuring the associated switches 565. One possible arrangement is that each of the switches 565 is sequentially turned on for each switching cycle. Voltage Vb of each cell 566ᵢ is monitored. When the cell voltage drops below a pre-determined threshold, the connected cell 566ᵢ will then be considered as “discharged” by control unit 567. The control unit then will not connect the “discharged” cell by keeping the corresponding switch open until the battery is charged again. With one or more of the “discharged” cells disconnected, the remaining cells continued to be switched on and off sequentially. The process can continue until all battery cells 566 are “discharged”. At or before the time when all battery cells are “discharged”, the battery pack can be switched to a charging mode and one or more battery can be charged. The above control algorithm can be repeated.

Sample control 3. Switch 565ᵢ associated with each battery cell 566ᵢ is turned on according to SOC (State of Charge) and/or SOH (State of Health) of the cell. Furthermore, the duration of the “on” duty cycle of switch 565 associated with each battery cell is proportional to SOC (State of Charge) and/or SOH (State of Health) of the cell. This helps to equalize SOC and/or SOH among the various cells during discharge. This scheme is referred to as wear-leveling of cells since it can level out the wear and tear of the cells.

Sample control 4. Switches 565ᵢ associated with all cells 566 are turned on during the same time interval for some period of time, and then individual switches 565ᵢ are turned off to stop drawing power from or recharging their respective cells.

While four examples are described above to demonstrate how to configure the BCC via control unit, the control unit can provide versatility and flexibility of the switching arrangements. Different switching and control algorithms can be used to optimize different application scenarios and objectives.

It is important to highlight that the relationship between cell terminal voltage and SOC is a function of the cell current, operating temperature, the SOH, and etc. Cell SOC can be inferred by cell terminal voltage with certain correction factors depending on the cell current and temperature. Alternatively, SOC can be measured using “coulomb counting”, by measuring the cell current and integrating over time. The monitor, control and charging management unit may measure and assess the cell SOC utilizing information related to the SOH of cells. Also, BCC system may open switch 565ᵢ for an individual cell 566ᵢ in order to measure open circuit cell voltage during cell voltage measurement for that cell. The capability of measuring open circuit cell voltage is a significant feature offered by BCC, which is not offered by conventional battery systems. This enables the internal resistance of an individual cell to be measured. The value of the cell internal resistance is an important indicator of the SOH of the cell since aged or degraded cells have higher internal resistances. The combined information between the “coulomb counting” and other parametric measurements can provide good estimates of SOC, SOH, and etc. when a proper battery model is applied.

For illustration purposes, some descriptions herein are based on simplified DC/DC converter schematics with specific switching sequence controls waveforms. Based on the disclosure and descriptions provided herein, it is obvious to a person skilled in the art to practice the present invention by modifying DC/DC switching topologies and switching sequence options without departing from the spirit of the present invention. The combination of battery cells and power converters incorporating embodiments of the present invention can improve battery pack usage efficiencies and increase battery pack useable time per charge. Furthermore, embodiments of the present invention can extend battery pack life-time and lower battery pack manufacturing cost. It is important to note that the battery cells incorporating embodiments of the present invention are not directly connected to the electrical load. Instead, the power is delivered to the electrical load through the DC/DC converter(s). Hence, in configurations that involve multiple DC/DC converters coupled to the battery cells via connecting devices, the main power is always being delivered to the electrical load via DC/DC converter(s). The electrical load refers to the primary load in the system that draws majority of the power from the battery cells. The is very different from descriptions of prior arts where the main power to the electrical load is delivered directly by the battery cells with the electrical load connected to the string of series-connected cells directly.

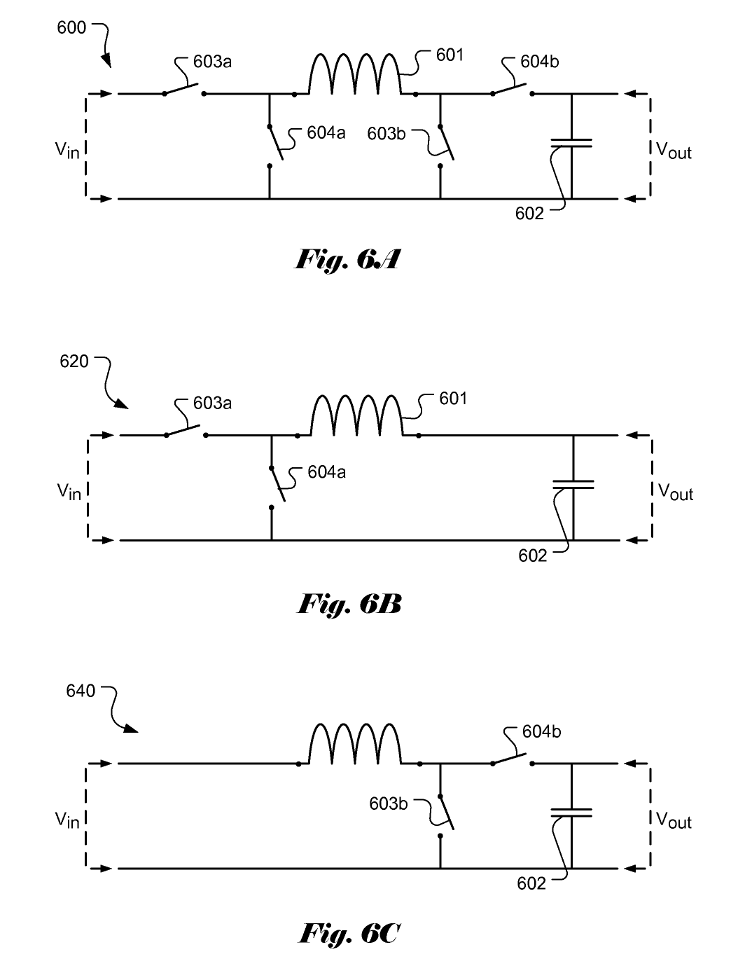

There are various types of DC/DC converters that can be used to implement embodiments of the present invention. For example, a step-up/step-down DC/DC converter 600 is shown in FIG. 6A. The DC/DC converter includes inductor 601, capacitor 602, connecting switches 603a-b and equalizing switches 604a-b. Connecting switches 603a-b and equalizing switches 604a-b are operated using non-overlapping clocks, while the duty cycle of such clocks determines the ratio of output voltage Vout to input voltage Vin. A detailed operation of DC/DC converter of FIG. 6A as well as other converters can be found in power electronics literatures such as “Fundamentals of Power Electronics” by Robert W. Erickson and Dragan Maksimovic. A step-down DC/DC converter 620 is shown in FIG. 6B, and a step-up DC/DC converter 640 is shown in FIG. 6C Both the step-up and step-down converters are similar to the converter of FIG. 6A. In FIG. 6B, only connecting switch 603a and equalizing switch 604a are used. In FIG. 6C, only connecting switch 603b and equalizing switch 604b are used. It will be clear to a person skilled in the art that the present invention may use all types of DC/DC converters from FIGS. 6A-C, with the understanding that the step-down converter can only have output voltage smaller or equal to the input voltage, while step-up converter can only have output voltage larger or equal to the input voltage.

A unique characteristic of BCC is that the switches coupled between the battery cells and the DC/DC converter can serve dual functions of being the connection devices for the battery cells as well as being part of the DC/DC converter. In other words, the DC/DC converter and the switching of the battery cells can be integrated into one building block. The switching controls of the switches (i.e., connecting devices) are integrated to provide control functions of managing the regulated output voltage of the DC/DC converter as well as enabling/disabling battery cells. Accordingly, the BCC system incorporating embodiments of the present invention optimizes the regulated output voltage as well as maximizes the pack system usable-time per charge and/or battery pack life-time. This capability is not described in any prior arts. In addition, a BCC unit incorporating embodiments of the present invention can have one or more battery cells coupled with one or more DC/DC converters with one or more voltage outputs. Another characteristic of the BCC is that the same DC/DC converter, or a part of it, can be used for delivering power from the battery cells as well as recharging the battery cells depending on the direction of current and power flow in the DC/DC converter.

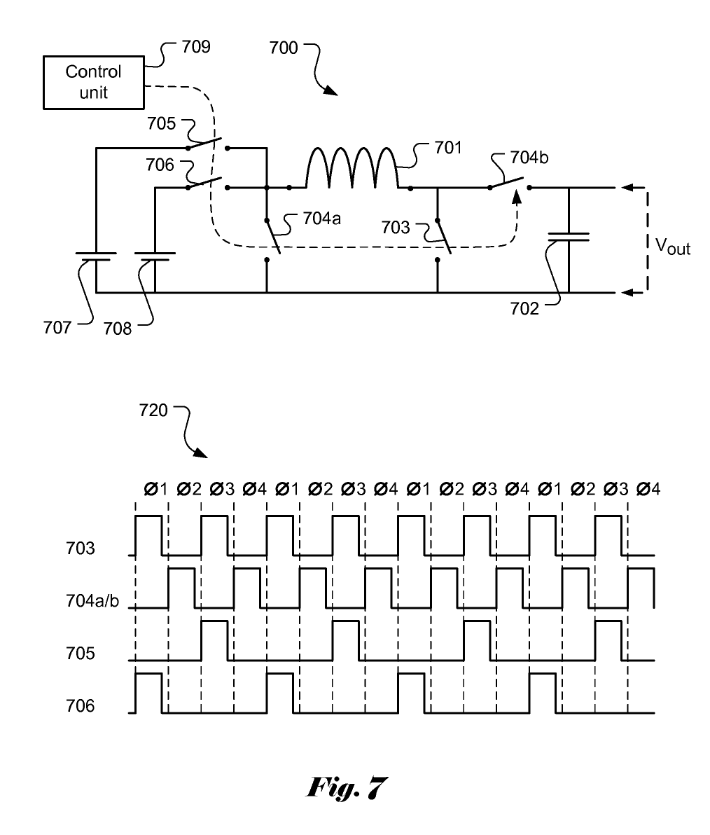

As mentioned previously in this disclosure, the switching sequence of switches coupled between the battery cells and the DC/DC converter is programmed to provide great flexibility. For example, the BCC system can be configured to share a DC/DC converter in the BCC unit as shown in FIG. 7. FIG. 7 illustrates an example of system 700, where the DC/DC converter comprises inductor 701, capacitor 702 and switches 703, 704a-b, 705, and 706. The DC/DC converter is shared between two battery cells 707 and 708. The switch control unit 709 provides control signal (shown as the dashed line) to ensure proper switches operation so as to achieve desired output voltage Vout. In the exemplary clock waveforms 720 shown in FIG. 7, switches 703-706 are operated in four clock-phase sequences, where switch 704 is closed for every other clock-phase sequence. The clock waveforms 720 as shown in FIG. 7 correspond to up-converter switching sequences. While specific clock waveforms are shown in FIG. 7 as an example to operate the BCC system, a person skilled in the art may practice the present invention using other clock-phasing arrangements. For example, it is possible to operate the power converter as a step-down converter or to use other clock-phase sequences. Note that the clock-phase 705/703 high followed by clock-phase 704a/b high utilizes extraction of charge from battery cell 707, and the sequence 706/703 high followed by 704a/b high utilizes extraction of charge from battery cell 708. Alternatively, switches 705 and 706 can be combined to use the same clock 703. In another example of present invention, control unit 709 can measure the SOC of the two batteries and make a decision as to which battery the charge is to be extracted. For example, if battery cell 707 has SOC smaller than that of battery cell 708, then the control unit will extract charge from battery cell 708 by configuring 706/703 high followed by 704a/b high in consecutive clock sequences, without asserting 705/703 high. The SOC of battery cell 708 will decrease until it becomes essentially equal to that of battery cell 707. The control unit 709 then extracts charge from the two battery cells alternatively. Therefore, this method ensures that the battery cells are discharged more uniformly, and no battery cell will have SOC substantially smaller than the rest of the battery cells in the pack. The capability of uniform cell discharge is important because the battery cell life can be prolonged by charging the battery cell often therefore avoiding full-discharge cycles for certain rechargeable batteries such as Lithium Ion batteries. In addition, the switching algorithms used in conjunction with switching of DC/DC converter control how charge is being drawn from individual cells. Consequently, any mismatch in cells will not limit battery pack performance. This unique advantage eliminates the need for separate, specific external components and the specific procedure of cell balancing during discharge.

Based on the disclosure and descriptions provided herein, it is clear to a skilled in the art that the discussion of system 700 can be generalized to the case of more than two battery cells. Moreover, a discussion of system 700 can also be generalized in case if battery cells 707 and/or 708 comprise more than one battery cell connected in series (as previously defined, a “cell”, also referred to as an “energy storage device” in this disclosure, is considered a single cell as a group of battery cells directly connected in parallel and/or in series).

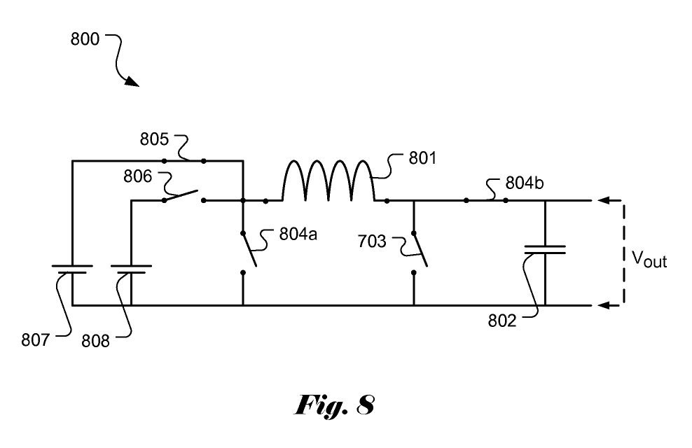

Charging of Battery Cell Converter unit incorporating embodiments of the present invention can also be done safely, as shown in FIG. 8, where the multi-cell battery unit 800 comprises inductor 801, capacitor 802, switches 803, 804a/b, 805, and 86, and battery cells 807 and 808. Since neither battery cell 807 nor battery cell 808 is connected in series with any other cell, each of the battery cells 807 and 808 can be imposed with an accurate voltage in the CV charging mode at the final charging stage. For example, the configuration in FIG. 8 shows the scenario that only battery cell 807 is connected to the DC/DC converter by closing switch 805 and opening switch 806. Therefore, the BCC topology eliminates the need of specific on-chip and off-chip components as well as the specific procedures for cell balancing during the charging process. Alternatively, the BCC can use its own switching regulator (DC/DC converter) to draw power from the Vout node to provide controlled recharging for the battery cells.

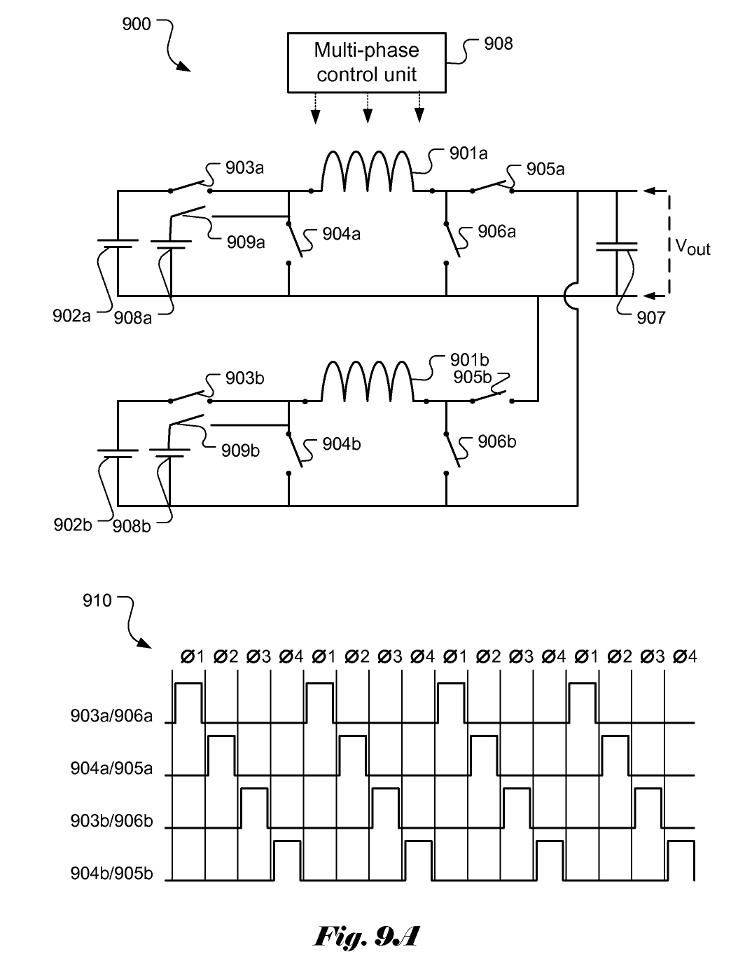

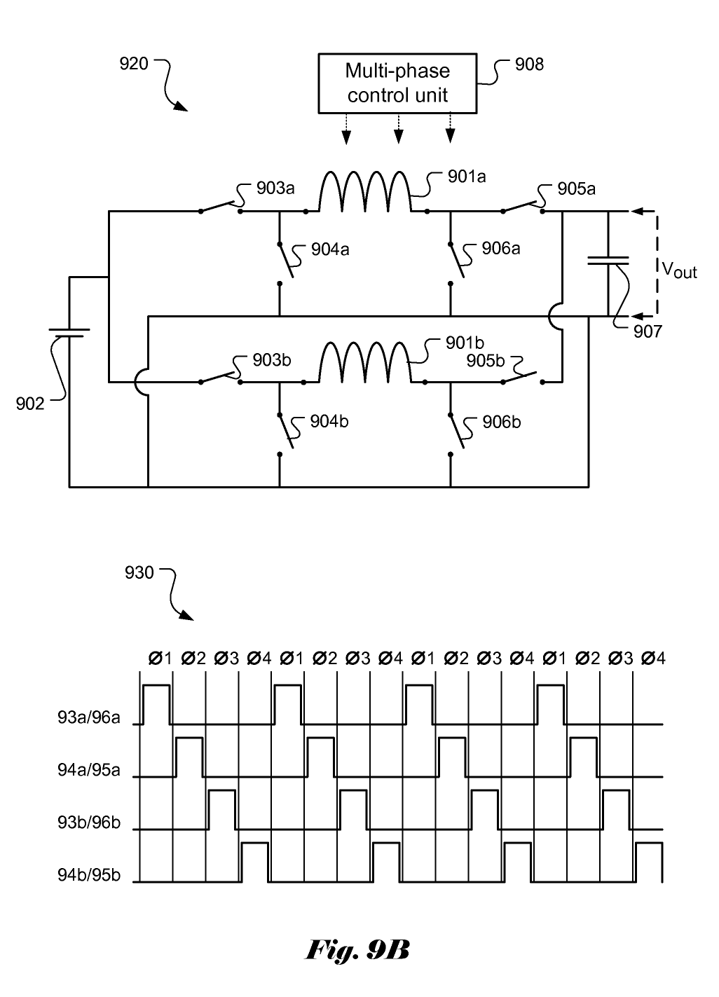

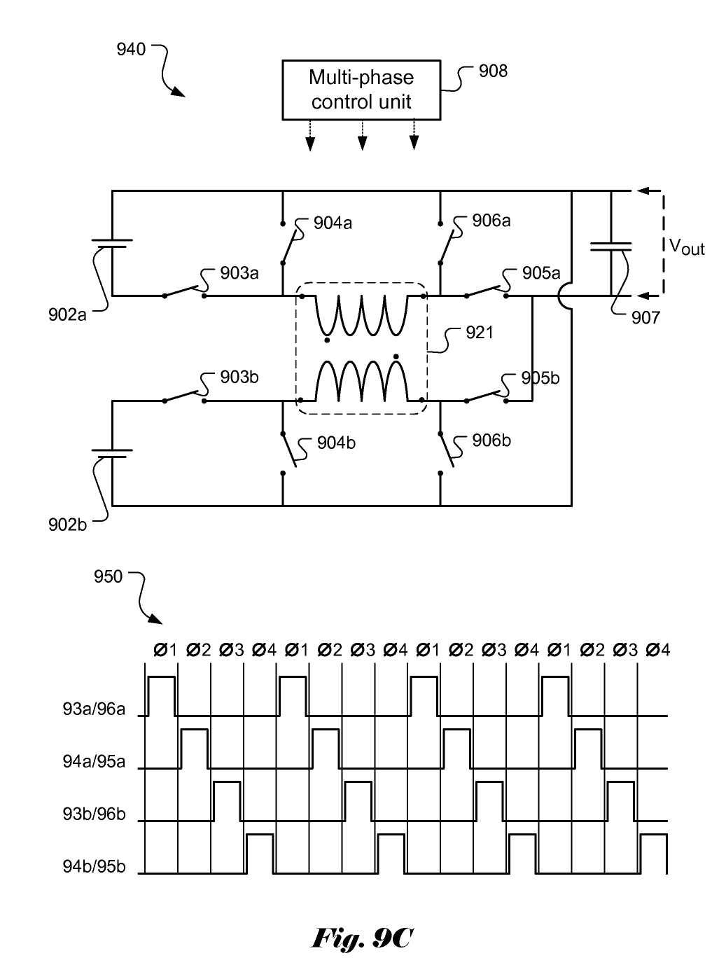

FIG. 9A illustrates an example of two-phase BCC system 900 incorporating an embodiment of the present invention. The system 900 includes two DC/DC converters or a single 2-phase converter having respective inductors 901a-b, battery cells 902a-b and 908a-b, switches 903a-b, 909a-b, 904a-b, 905a-b, and 906a-b, a common shared capacitor 907 coupled to the output of the BCC system 900, and a multi-phase control unit 908. The multi-phase control unit 908 controls clock phases of the switches to ensure that the system operates in correct 2-phase cycles. The control signals are shown as dashed arrows from multi-phase control unit 908 in FIG. 9A. The exemplary switch clocking diagrams 910 are also depicted in FIG. 9A, where the switch is in “short” state when its clock is high and the switch is in “open” state when its clock is low. An alternative two-phase BCC system 920 is shown in FIG. 9B. The BCC system in FIG. 9B is similar to the system in FIG. 9A except that the 2-phase DC/DC converter is coupled to the same battery cell 902. The clock waveforms 930 are shown in FIG. 9B. FIG. 9C illustrates another variation of two-phase BCC system 940 with corresponding clock waveform 950. Compared with the BCC system in FIG. 9A, the alternative system uses a coupled inductor unit 901 to replace the two separate inductors 901a-b, which allows a more efficient DC/DC converter operation with faster startup time. While three exemplary embodiments of the present invention are shown in FIGS. 9A/9B/9C, a person skilled in the art may practice the invention by rearranging the exemplary circuits. For example, a shared battery could also be used in a coupled inductor system. Furthermore, while a two-phase system is shown as an example, a BCC system may use any number of phases along with additional hardware related to the implementation of multi-phase DC/DC converter(s).

A multi-phase BCC system also provides flexibility and capability to extend battery life. For example, in case one of the battery cells in a 4-phase BCC system becomes defective, the system control unit can detect the circumstance and disconnect the defective cell from the system if the cells are connected in the parallel mode. Alternatively, the control unit can reconfigure the 4-phase system into a 3-phase system if the cells are connected individually to the input of each phase of the power converter. It clearly shows that a BCC system incorporating embodiments of the present invention can allow battery packs to continue to operate even with some defective cells.

In addition, switching algorithms are used to support load-dependent and/or SOC-dependent adaptive system configuration. The switching algorithms automatically reconfigure multi-cell, multi-phase BCC system to compensate for any mismatch in the system. This enables the system to optimize system power consumptions and further enhances the ability to extend battery pack per-charge use-time.

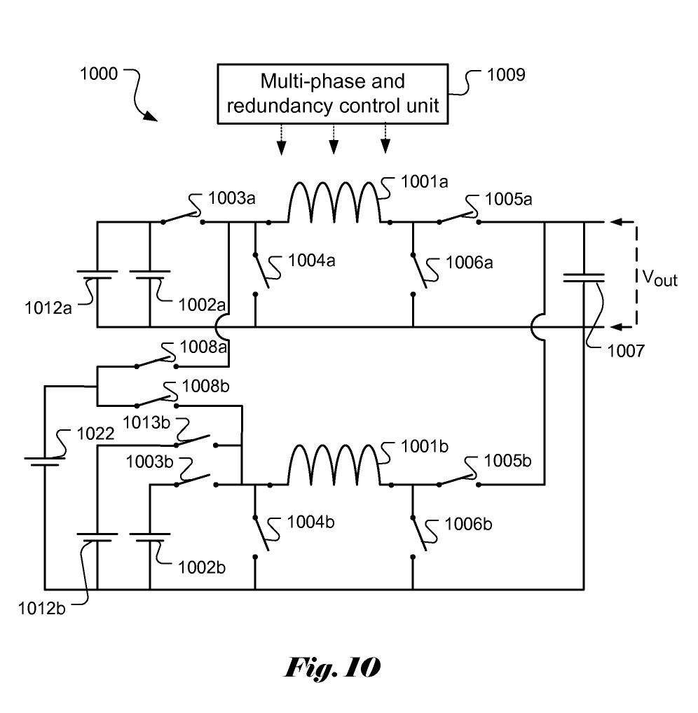

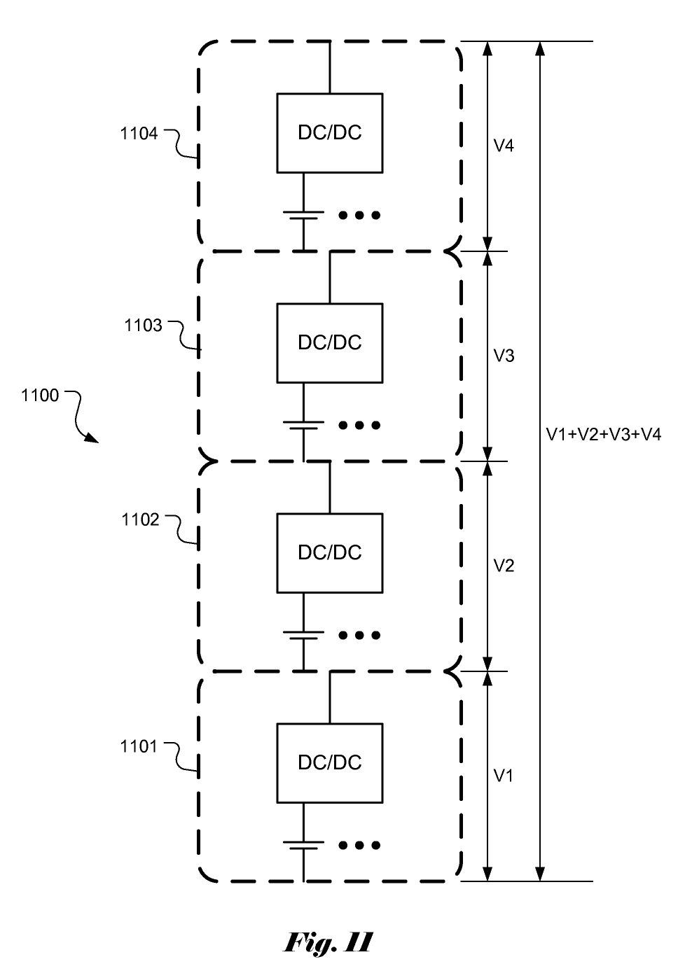

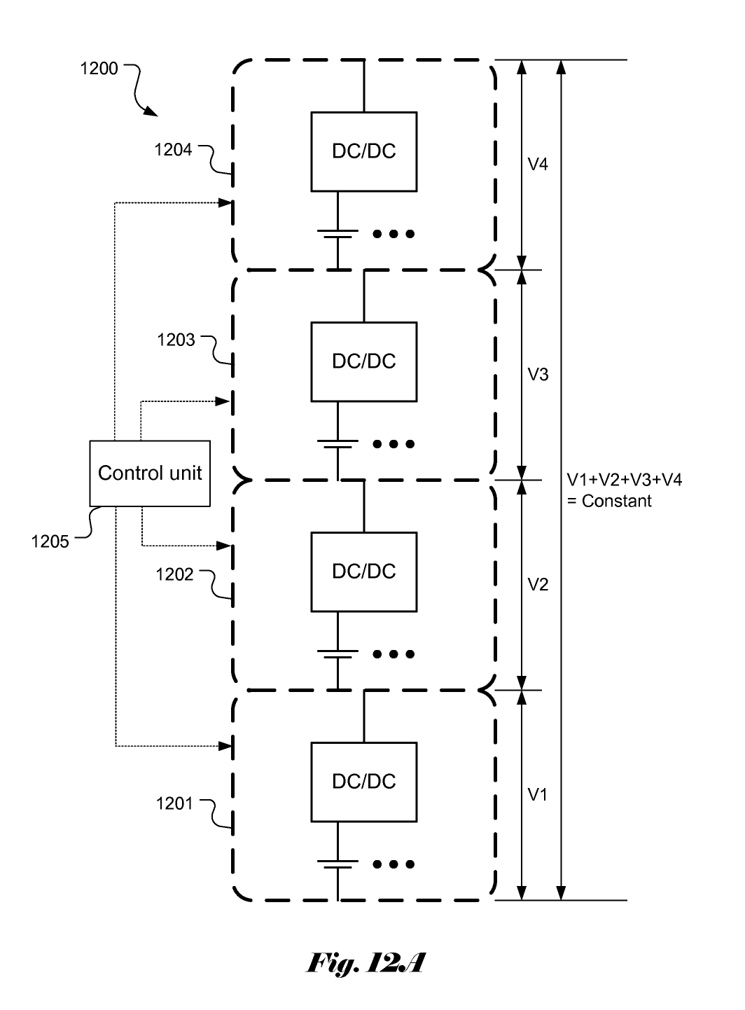

FIG. 10 illustrates exemplary 2-phase BCC system 1000 with different types of charge cell redundancy. Cells 1002a and 1012a are simultaneously coupled to a DC/DC converter which includes inductor 1001a, switches 1003a through 1006a. The switches are configured to deliver charge to output capacitor 1007. Cell 1012a is connected in parallel with cell 1002a to reduce the rate of discharge of cell 1002a during operation. Local redundancy is depicted in the cells coupled to the second or second-phase of DC/DC converter including inductor 1001b, switches 1003b through 1006b and 1012b. The switches are configured to deliver charge to the output capacitor 1007. Battery cells 1002b and 1012b are connected to separate switches 1003b and 1013b, and therefore can be operated one at a time. On the other hand, cells 1002a and 1012a are connected “directly” in parallel. If battery cell 1002b is discharged, cell 1012b can be used in further operation so that the BCC system can continue to function. Alternatively, switches 1003b and 1013b can be time-multiplexed to allow charges to be drawn from cells 1002b and 1012b respectively based on duty-cycled clocking sequence. The configuration in FIG. 10 illustrates that battery cell 1012b can only “help” cell 1002b. Since there is no path for cell 1012b to be coupled to the DC/DC converter in the upper half, cell 1012b cannot “help” cells 1002a or 1012a. The redundancy arrangement between 1002a and 1012a and the redundancy between 1002b and 1012b are referred as “local” redundancy.

In order to provide global redundancy, battery cell 1022 is added, which can “help” cells in the top section as well in the bottom section. Battery cell 1022 can be coupled to the DC/DC converter in the top section through switch 1008a or to the DC/DC converter in the bottom section through switch 1008b. Therefore, battery cell 1022 can replace any battery cell in the pack in case that the battery cell fails. A multi-phase clock and redundancy control unit 1009 provides control signals as well as the clocks of the two-phase BCC system 1000 to ensure proper operation as described in conjunction with FIGS. 9A/9B/9C. In addition, the multi-phase clock and redundancy control unit 1009 provides control signal for configuring redundancy cell connection. For example, the control unit 1009 may cause one or more switches (i.e., 1003b, 1013b, and 1008b) closed to deliver charge to inductor 1001b from one or more cells (i.e., 1002b, 1012b and 1022). Similarly, the control unit 1009 may cause one or more switches (i.e., 1003a, 1013a, and 1008a) closed to deliver charge to inductor 1001a from one or more (i.e., cells 1002a, 1012a and 1022). In one embodiment, the clock and redundancy control unit 1009 may monitor the SOC of battery cells such as voltage output and charge fuel gauging, and configure the switches in a way that the strongest cells deliver charge first. Therefore, the discharging rate of the cells can be equalized through equalized SOC.

While a specific example is illustrated in FIG. 10 for global and local redundancies in a multi-phase BCC system with multiple DC/DC converters, a person skilled in the art may practice the present invention rearranging the circuits, adding more local redundancy paths, adding more global redundancy paths, or using more clock phases.

If high output voltage such as 48V or higher is desired, conventional solutions will simply stack a series of battery cells. As the number of series-connected cells increase, it is obvious that the problems relating to cell mismatch during charging and discharging will become worse drastically. If one cell becomes defective, the entire series-stacked cell chain will become defective. A stacked-BCC structure incorporating embodiments of the present invention will eliminate or alleviate many of these undesirable characteristics in the conventional approach.

For applications that require high output voltage and/or high current such as the battery pack for an EV (Electrical Vehicle) or Hybrid EV, the system may require output more than 300V and more than 100 A. Conventional battery pack design would stack Li-ion cells in series strings in the order of 100 cells or more. The performance of highly stacked cells will be limited by the weakest cell as discussed earlier. In principal, a single BCC with a boost DC/DC converter can be used to provide high output voltage, where the DC/DC converter can up convert the battery cell voltage directly to a high output voltage. Nevertheless, it may not necessarily be the most desirable configuration due to the following reasons described as follows.

For one reason, if a single boost converter is used, the up conversion ratio will need to be in the order of 100 to provide 300V output voltage. This would require many circuit components of the boost converter to be able to withstand more than 300V and the input current of the boost converter to be very high. Using high voltage transistors to support high current conduction usually is not very efficient and it will incur higher system cost.

For another reason, the hardware design is often optimized for a certain up-conversion ratio with a desired range of output power and the conversion efficiency may degrade noticeably if it is used beyond the intended conversion ratio. For example, the efficiency may drops from 95% down to 85%.

In practice, it is desirable to develop a scalable design. With a modular design, multiple modules can be connected in parallel to achieve higher current and/or multiple modules can be stacked up to achieve higher output voltage. Accordingly, a BCC system incorporating an embodiment of the present invention offers scalability as an important feature.

FIG. 11 shows a modular BCC system 1100 incorporating an embodiment of the present invention, where the system comprises four stacked-BCC module units 1101-1104. The BCC module is based on a design incorporating embodiment of the present invention. For example, any of the BCC systems, such as the BCC system in FIGS. 5A/B, 7, 8, 9A/B/C and 10, can be used as a BCC module unit. In the example of FIG. 11, the four BCC modules provide regulated output voltage V1 through V4 respectively. The output voltages V1 through V4 in FIG. 11 are not necessarily equal. The stack-up configuration shown in FIG. 11 will result in the output voltage of the modular BCC system 1100 to be V1+V2+V3+V4. Furthermore, if the charge in one BCC module-unit is prematurely weakened (e.g., module-unit 1102), it would be highly desirable to reduce the amount of charge drawn from this module unit and let the more healthy module-units to support higher portion of the electrical load. Therefore, using SOC/SOH and other monitored parametric information, the desirable characteristics can be achieved by simply programming the output of the weaker module to a lower voltage and the output voltages of healthier modules to higher voltages. Consequently, the sum of all output voltage of each of the stacked module is equal to the original desired pre-determined value. Since the output current through each of the stacked-modules or through the output of each of the stacked-DC/DC converters is the same, therefore lower output power is drawn from the module with lower output voltage. On the other hand, higher power is drawn from these modules with higher output voltages. For example, a control unit (not explicitly shown in FIG. 11) can provide control signals for lowering the output voltage V2 (e.g., module-unit 1102 is weaker than the other 3 stacked modules) while increasing the output voltages V1, V3 and V4 in order to maintain V1+V2+V3+V4 at the original desired value. The monitored parametric values may correspond to voltage of individual battery cell, the output voltage of the DC/DC converter, the quantity of charges being charged or discharged (named charge fuel gauging), and temperature. Furthermore, the history of SOC, SOH and any of the monitored parameter values may also be used by the control unit. Accordingly, the BCC system incorporating an embodiment of the present invention provides the capability and flexibility to manage drawing charge from the battery cell based on the SOC/SOH and other monitored parametric values. Consequently, the system is able to manage the health and aging mechanism of the entire battery system and to extend the “operating time per charge” as well as the “operating life-time” of the entire battery system. This capability to “manage” the cell aging and hence to optimize the battery system operating life-time is new and unique.

In addition, a side benefit of employing stacked BCC topology is that there is no need for a very high-voltage silicon process to support an overall high voltage stacked output, because each BCC module generates a voltage substantially lower than the total output voltage. This broadens the possible selections of process technologies and allows the design of highly integrated and efficient power converters. The BCC module stacking according to embodiments of the present invention stacks the programmable, regulated outputs of the DC/DC converters of the stacked-BCC units. On the other hand, prior arts have the battery cells themselves connected as a string of series-stacked battery configuration.

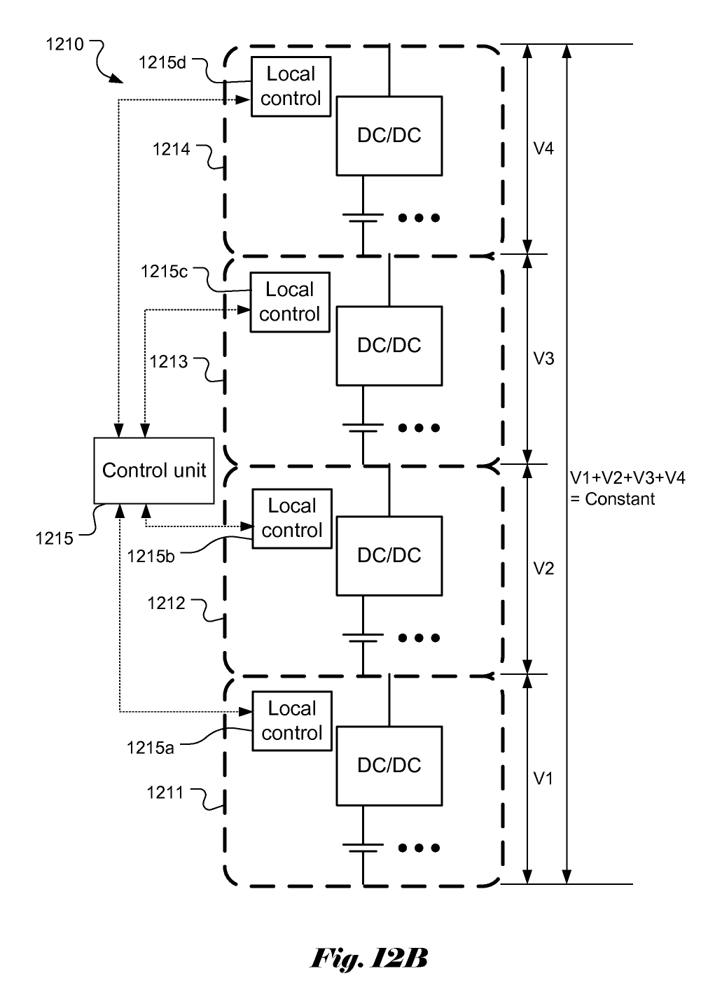

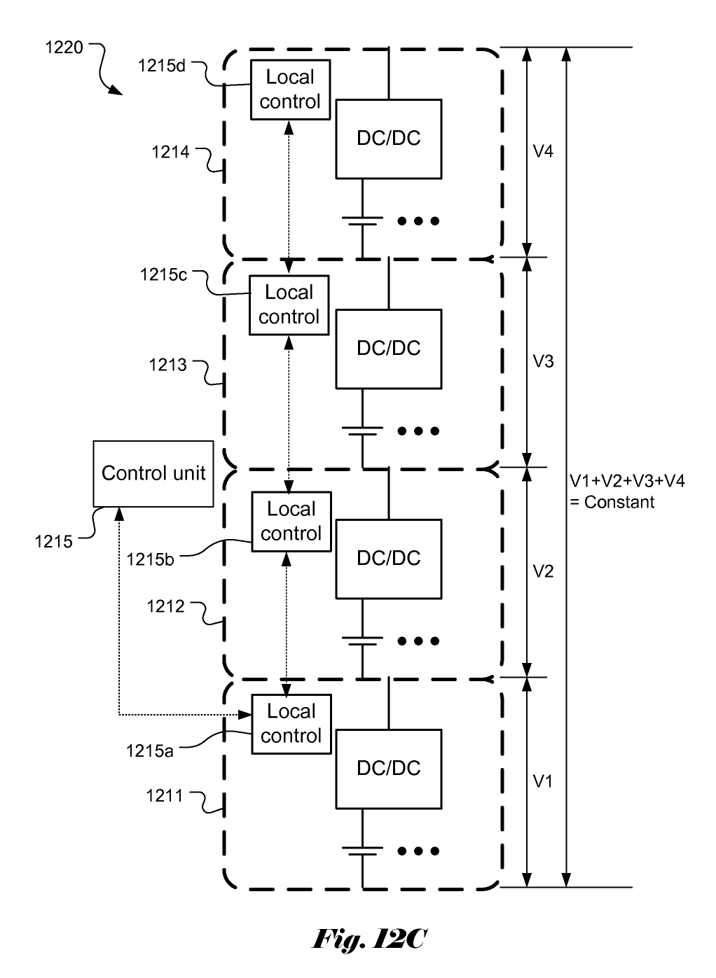

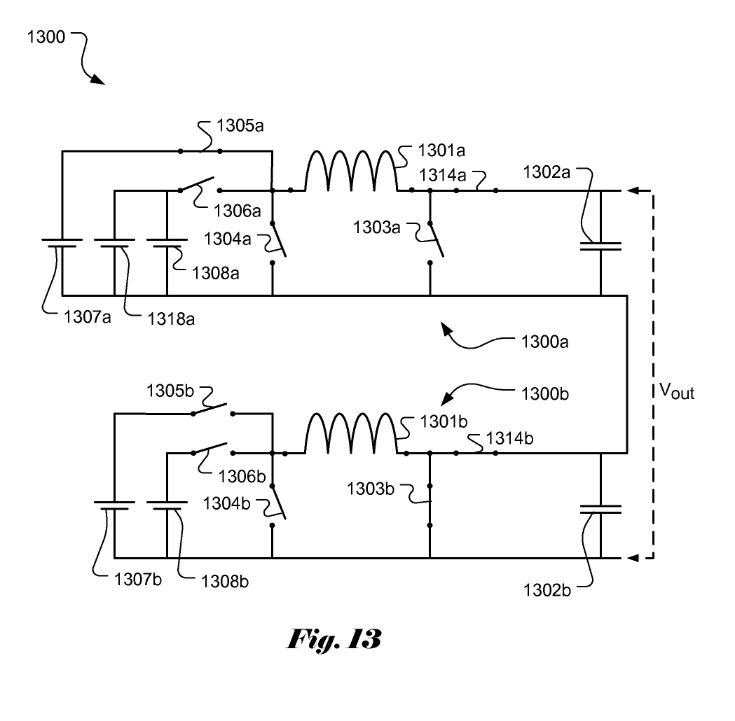

FIG. 12A shows another embodiment of BCC unit 1200 which includes four stacked-BCC module units 1201 to 1204 having output voltages V1 to V4 respectively. Control unit 1205 provides control signals for controlling settings of DC/DC converters in 1201 to 1204 so that BCC module units 1201 to 1204 generate prescribed output voltages V1 to V4. By measuring SOC, SOH and other monitored parametric values of the battery cells within units 1201 to 1204, control unit 1205 adjusts output voltages so that the output voltage is set according to the SOC, SOH and other parametric values of the BCC unit. Furthermore, in the example of FIG. 12A, control unit 1205 configures the BCC system so that the sum V1+V2+V3+V4 remains at a desired output voltage value. The control unit will configure the system by reducing power drainage of the weakest battery cell and accordingly prolong the lifetime of the stacked cell battery system 1200.

FIG. 12B shows another example of stacked BBC system 1210 comprising BCC module units 1211 to 1214, where module units have individual local control units 1215a-d to monitor, control and manage charging of respective module units. The local control units 1215a-d are connected to a centralized controller 1215 as shown in FIG. 12B. The interface signaling of the system in FIG. 12B can be carefully designed so that only the central controller 1215 may need to be able to support high voltage. This architecture allows the design of the stacked BCC units to be modular and be able to communicate to the main controller 1215. The dashed lines between the main control unit 1215 and local controls 1215a-d are the communication links. Alternatively, the communication between the main control unit 1215 and local controls 1215a-d can be achieved by daisy-chaining between the controllers as shown in the BCC system 1220 of FIG. 12C. This has a unique advantage that none of the controller, including the central controller 1215 is exposed to high voltage.

For stacked BCC architecture as shown in FIGS. 12A, 12B and 12C, it is possible to operate the DC/DC converters in each stack at different phases. The phases between the controllers at various stacked levels are synchronized so that a multiphase converter system can be achieved for the final stacked output. The output ripple voltages at the final stacked output can be cancelled. Based on the disclosure and descriptions provided herein, it is clear to a person skilled in the art to practice the present invention using different number of stacked BCC modular-units.

As previously mentioned, a stacked BCC topology of multi- or single-cell units ease the challenges of charging and discharging battery cells as described in this disclosure. The cells in the stacked BCC structure can still be charged independently since the BCC system according to the present invention stacks up the DC/DC converter outputs instead of the battery cells themselves. An example is shown in FIG. 13, where a DC/DC converter-coupled multi-cell batteries BCC system 1300 incorporates an embodiment of the present invention comprises two stacked BCC sub-units 1300a-b. BCC sub-unit 1300a comprises inductor 1301a, capacitor 1302a, battery cells 1307a, 1308a, and 1318a and switches 1303a-1306a and 1314a. BCC sub-unit 1300b comprises inductor 1301b, capacitor 1302b, battery cells 1307b, and 1308b and switches 1303b-1306b and 1314b. The charging mechanism of each of the stacked BCC unit is similar to that of the non-stacked BCC units as described earlier in this disclosure. A person skilled in the art may practice the present invention by using any number of stacked BCC units, where each unit may have an arbitrary number of battery cells. It is important to point out again that the system with the BCC topology stacks is the DC/DC outputs instead of stacking up the battery cells in series as a conventional system.

While examples of stacked BCC module-units in series to achieve higher output voltages have been shown above, embodiments of the present invention can also be applied to connect individual BCC module-units in parallel to achieve higher output currents. In addition, a combination of stacked BCC module-units in series and multiple BCC module-units connected in parallel can be used to achieve higher output voltage and higher output current concurrently. For example, multiple parallel-connected BCC modules can be connected in series to achieve higher output voltage and higher output current concurrently. The BCC system embodiment the present invention can adjust the current output of each stack module unit individually to a desired level according to the SOC/SOH and monitored parameters of battery cells. A variety of control algorithms can be used to maintain the appropriate currents from each stack while regulating the output voltage. As an example, each module can be controlled to produce a desired voltage level using a programmable equivalent output resistance. In summary, the BCC system disclosure here can scale the output voltage as well as the output current. This is analogous to putting BCC module-units in a matrix.

Furthermore, the BCC system incorporating embodiments of the present invention allows different battery cell types or different cell chemistries mixed in a battery pack. It is particularly useful in a large scale battery pack that consists of many BCC modules stacked in series and/or connected in parallel. For example, each BCC module can have battery cells of different types, and the output voltage and current will be programmed in accordance with the cell types. Such mixed-type BCC modules can be managed together to form a single overall battery system according to the present invention. This ability eases battery system design and battery system maintenance. It also provides the ability to extend and/or optimize battery system life-time. In addition, the BCC system according to the present invention makes it possible to create battery “after-markets” or battery “2^{nd}-life markets” since these modules can be mixed and matched between new/old units, or different types.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A battery-cell converter system, comprising:
one or more battery-cell converter units, wherein each battery-cell converter unit comprises:
an electrical energy storage cell bank comprising of a plurality of energy storage devices, wherein each energy storage device comprises a first terminal and a second terminal, and wherein the first terminal corresponds to a positive terminal or a negative terminal, and the second terminal has an opposite polarity from the first terminal;
one or more DC/DC converters, wherein each DC/DC converter includes one or more inputs and one or more outputs;
one or more electrical connection devices coupled to the plurality of energy storage devices and said one or more DC/DC converters; and
a monitor and control module coupled to the plurality of energy storage devices, said one or more DC/DC converters, and said one or more electrical connection devices to monitor and control said one or more battery-cell converter units, wherein each energy storage device is connected to at least one input of said one or more DC/DC converters in at least one configuration of said one or more electrical connection devices as configured by the monitor and control module; and
wherein said one or more battery-cell converter units are configured to provide one or more regulated main power outputs from said one or more outputs of said one or more DC/DC converters of said one or more battery-cell converter units.

2. The system of claim 1, wherein said monitor and control module is configured to:
monitor status and/or characteristics of the plurality of energy storage devices, said one or more DC/DC converters, or a combination thereof during charging or discharging of the plurality of energy storage devices; and
control said one or more electrical connection devices, said one or more DC/DC converters, or the combination thereof during charging or discharging of the plurality of energy storage devices.

3. The system of claim 1, wherein said one or more electrical connection devices are configured to cause one or more of the plurality of energy storage devices to be connected to or disconnected from said one or more DC/DC converters.

4. The system of claim 1, wherein the first terminal of each energy storage device is connected to one of one or more common nodes and the second terminal of each energy storage device is connected to at least one electrical connection device.

5. The system of claim 4, wherein said one or more DC/DC converters correspond to a first DC/DC converter and a second DC/DC converter, and one energy storage device is connected to the first DC/DC converter in first configuration of said one or more electrical connection devices and said one energy storage device is connected to the second DC/DC converter in second configuration of said one or more electrical connection devices.

6. The system of claim 1, wherein the monitor and control module is adapted to control said one or more electrical connection devices based upon a characteristic from a group consisting of:
current flow;
state of charge;
state of health;
voltage;
charge fuel gauging;
temperature; and
history of any of the above characteristics.

7. The system of claim 1, wherein two or more battery-cell converter units are connected in series, parallel or a combination thereof.

8. The system of claim 7, wherein sum of output voltages of said two or more battery-cell converter units connected in series is configured to provide a desired output voltage or sum of output currents of said two or more battery-cell converter units connected in parallel is configured to provide a desired output current.

9. The system of claim 8, wherein the monitor and control module sets the output voltages or the output currents for each battery-cell converter unit based upon a status of each energy storage device from a group consisting of:
state of health;
state of charge;
voltage;
charge fuel gauging;
temperature; and
history of any of the above characteristics.

10. The system of claim 1, wherein the monitor and control module unit has a means to communicate with one or more other monitor and control module units.

11. The system of claim 1, further comprising a main system control unit coupled to the monitor and control module of each battery-cell converter unit, wherein the main system control unit determines output voltages, output currents, or current-voltage load-lines for said one or more battery-cell converters unit based upon a status of said one or more battery-cell converters.

12. The system of claim 1, wherein each DC/DC converter corresponds to a single-phase converter or a multi-phase converter.

13. The system of claim 1, wherein at least one DC/DC converter is a multi-phase converter and said at least one DC/DC converter is coupled to the plurality of energy storage devices by one of following means:
said at least one DC/DC converter is coupled to all of the plurality of energy storage devices at a common set of input terminals;
circuits associated with different phases of said at least one DC/DC converter are coupled to corresponding subsets of the plurality of energy storage devices in parallel; and
each of said circuits associated with one phase of said at least one DC/DC converter is coupled to one of the plurality of energy storage devices by configuring said one or more electrical connection devices.

14. The system of claim 1, wherein at least one DC/DC converter is a multi-phase converter, and the monitor and control module is adapted to perform at least one function from a group consisting of:
altering phase controls of said at least one DC/DC converter;
altering duty cycles of said at least one DC/DC converter;
changing the number of phases of said at least one DC/DC converter;
altering a desired output voltage of said at least one DC/DC converter;
altering a desired output current of said at least one DC/DC converter; and
altering desired currents associated with individual phases of said at least one DC/DC converter.

15. The system of claim 1, wherein said one or more inputs of said one or more DC/DC converters are switched to an external charging source if presence of the external charging source is detected by the monitor and control module or a main monitor and control module.

16. The system of claim 1, wherein said one or more outputs of said one or more DC/DC converters are switched to one or more external charging sources if presence of said one or more external charging sources are detected by the monitor and control module or a main monitor and control module, where said one or more DC/DC converters are operated at negative forward power to charge the plurality of energy storage devices.

17. The system of claim 1, wherein said one or more regulated main power outputs are switched to one or more external charging sources if presence of said one or more external charging sources are detected by the monitor and control module or a main monitor and control module.

18. The system of claim 1, wherein said one or more battery-cell converter units are configured by the monitor and control module or a main monitor and control module to cause the battery-cell converter system to draw less charge from a weaker energy storage device than a stronger energy storage device.

19. The system of claim 1, wherein said one or more battery-cell converter units are configured by the monitor and control module or a main monitor and control module to cause a defective energy storage device disconnected from the battery-cell converter system.

20. The system of claim 1, wherein said one or more battery-cell converter units are configured by the monitor and control module or a main monitor and control module to cause a weaker energy storage device connected to said one or more inputs of said one or more DC/DC converters for a shorter period than a stronger energy storage device.
